(19) United States
(12) Patent Application Publication
(10) Pub. No.: US 2010/0065212 A1
(43) Pub. Date: Mar. 18, 2010

(54) Pressure-sensitive adhesive tape for solar panels

(75) Inventors: Marc HUSEMANN, Hamburg (DE); Bernd BUNDE, Hamburg (DE); Reinhard STORBECK, Hamburg (DE); Lesmona SCHERF, Hamburg (DE)

Correspondence Address: Briscoe, Kurt G.;Norris McLaughlin & Marcus, PA, 875 Third Avenue, 8th Floor, New York, NY, 10022, US

(73) Assignee: Tesa SE, Hamburg (DE)

(21) Appl. No.: 12/560,973

(22) Filed: Sep. 16, 2009

(30) Foreign Application Priority Data
Sep. 18, 2008 (DE) 10 2008 047 965.9

(51) Int. Cl. B32B 27/30; B32B 7/02

(52) U.S. Cl. 156/332; 428/212

(57) ABSTRACT

Pressure-sensitive adhesive tape having
(i) a transparent carrier film and
(ii) a layer of a transparent pressure-sensitive adhesive,
wherein
   the carrier film has a refractive index n_{d}²⁰ of not more than 1.458 and a transmittance of greater than or equal to 90%,
   the pressure-sensitive adhesive layer has a refractive index n_{d}²⁰ of at least 1.470 and a transmittance of at least 90%;
   the transmittance of the adhesive tape in the bonded state on a glass plate is at least 90%.
      The adhesive tape is useful for bonding components of solar modules.

The invention relates to a single-sided pressure-sensitive adhesive tape for producing solar modules. Specifically it concerns a single-sided adhesive tape which can be used in different areas in the production and use of solar modules.

Recent years have seen a drastic rise in interest in regenerative energy sources, especially solar energy. An exponentially increasing global energy consumption, the scarcity of non-renewable energy sources, and legal regulations relating to green electricity will lead, in the coming years, to a sharp rise in the generation of electricity through sunlight. One consequence is the intensified research and development in the area of solar cells and solar modules. The focus of this is the simplification and optimization of the processes and production methods, and the reduction in costs of the raw materials and components. A further aim is to reduce the overall thickness of solar modules while leaving their stability unaffected.

“Thick-layer” solar modules with silicon solar cells are presently the most densely represented on the market and are offered preferentially comprising a laminate with the embedded solar cells, a glass front, and an aluminium frame surrounding the module. The production of thin-film solar modules, where the cells are composed, for example, of semiconducting materials applied by vapour deposition to a variety of substrates, is being expanded.

Adhesive tapes are being used increasingly in the production of solar modules (also referred to in the literature as solar panels, photovoltaic modules and solar generators) on account of their tidiness and cost-effectiveness and their capacity to simplify the process. Examples of adhesive tapes in solar modules are frame bonding and switching-socket bonding, the protection of the glass surface or the fixing of the solar cells prior to the laminating operation. In the laminating operation of a solar module, the sensitive silicon solar cells are embedded between sheets of a fusible adhesive bonding foil at approximately 150° C. for at least 15 minutes under reduced pressure. Frame bonding, for example, is carried out preferably with a double-sided adhesive tape rather than with a silicone bond, since the operation is partly automated and hence quicker, more uniform, and tidier.

For different applications during the production of modules there are different adhesive tapes on the market, tailored to the applications.

Important requirements imposed on the adhesive tapes are UV stability, weathering resistance and optical transparency. The UV stability and weathering resistance and also the mechanical robustness of solar modules are examined by tests which are described in IEC standard 61215. The provisions of that standard are the basis for the specific climatic resistance test conditions under which not least the adhesive tapes used ought to exhibit consistent optical, chemical and adhesive properties.

Described below are specific adhesive tape applications for solar modules.

For single-sided pressure-sensitive adhesive tapes, the applications are in the positioning and fixing of solar cells (graphic 1) and also the fixing of the laminate (graphic 2) prior to the laminating operation, and the protection of the glass front (graphic 2) of solar modules.

Cell fixing is presently a step which is primarily carried out manually during the production of the module, and involves the individual, sensitive solar cells being placed on the fusible EVA foil and fixed using the single-sided adhesive tape, so that the cells do not shift relative to one another in the course of the laminating step.

Existing adhesive tape solutions are frequently equipped with a polypropylene and/or polyethylene or cellulose acetate carrier material, which has been demonstrated to become fragile or destroyed after UV exposure. Additionally, in the adhesive tapes employed at present, resin-blended adhesives are used, and these adhesives, on UV exposure, exhibit discoloration and are subject to outgassing under the influence of high temperatures.

There is therefore a need for an adhesive tape for cell fixing which ought to possess improved outgassing and contraction characteristics and also to possess a lower tendency towards blistering, and which prevents shifting of the solar cells at high temperatures in the course of lamination. Moreover, the adhesive tape requires very good UV stability, since the cell fixing tape remains in the laminate, and discoloration or fragility of the adhesive tape would detract from the external optical appearance of the solar module.

The adhesive laminate-fixing tape fulfils a function similar to that of the cell fixing adhesive tape; in this case, the intention is to protect the different layers of the module laminate from shifting.

At the present time, specific single-sided adhesive tapes with silicone adhesives are in use, which are removed again after the lamination of the layers, so that the aluminum profiles can be bonded at the edge. This entails a further operating step, which it would be preferable to omit.

There is therefore a need for a thin adhesive tape which following lamination of the layers is able to remain in the solar module and which has no adverse effect on the construction or functioning of the solar module. This likewise relates to the subsequent application of the aluminium frame.

A glass protection film on the glass front of a solar module may fulfil various functions, such as, for example, the improved transmission of incident light by the front face of the module, or anti-splinter protection for the glass surface.

Existing modules are frequently provided with protective glasses having a thickness of about 3 to 4 mm, in order to ensure mechanical stability of the module as a whole. This entails a relatively high weight for the solar module. In order to reduce the thickness of protective glass, there is a need for a protective film which stabilizes the sheet of glass beneath it, allowing the latter to be significantly reduced in thickness. The protective film might also apply functional layers as well, thereby making a specific surface treatment of the glass unnecessary.

The applications described illustrate the fact that very different requirements apply according to the way in which the single-sided pressure-sensitive adhesive tape is used in the solar module. At the present time this entails an increasing complexity, since very different pressure-sensitive adhesive tapes are used. In order to simplify and accelerate the production operation for solar modules, however, there is a need for a single-sided self-adhesive tape which can be used universally for all of the stated applications, and similar applications, and which minimizes or does not have the existing weaknesses of the present solutions.

The object can be achieved, surprisingly and unforeseeably, by a highly transparent, single-sided, pressure-sensitive adhesive tape having a specific carrier construction.

This invention provides, in particular, single-sided pressure-sensitive adhesive tapes composed of

i) a transparent carrier film having a refractive index n_{d}²⁰ (refractive index for the sodium d line corresponding to 589 mm at 20° C.) of less than or equal to 1.458 and a transmittance of greater than or equal to 90%,
ii) a transparent pressure-sensitive adhesive having a refractive index n_{d}²⁰ of greater than or equal to 1.470 and a transmittance of greater than or equal to 90%,
the carrier film and pressure-sensitive adhesive being selected such that they have a high

UV stability, low outgassing characteristics and a high temperature stability, and the light transmittance in accordance with ASTM 1003 after the bonding of a single-sided pressure-sensitive adhesive tape to a sheet of glass has a light transmittance of greater than or equal to 90%.

In designing and configuring optical components, such as glass windows, for example, account must be taken of the interaction of the materials used with the type of irradiated light. In a derived version, the law of energy conservation adopts the following form:

T(λ)+p(λ)+a(λ)=1

where T(λ) describes the fraction of light transmitted, p(λ) describes the fraction of light reflected, and a(λ) describes the fraction of light absorbed (λ: wavelength of the light), and where the overall intensity of the irradiated light is standardized to 1. Depending on the application of the optical component, the task at hand is to optimize one or more of these three terms and to suppress the other or others. Optical components which are designed for transmission ought to have values for T(λ) that are close to 1. This is achieved by reducing the values of p(λ) and a(λ). Transparent acrylate PSAs normally have no significant absorption in the visible range, i.e. in the wavelength range between 400 nm and 700 nm. This can easily be ascertained by measurements with a UV-Vis spectrophotometer. It is therefore p(λ) that is of decisive interest. Reflection is an interfacial phenomenon which is dependent on the refractive indices n_{d,i} of two phases i in contact, in accordance with the Fresnel equation

$$ρ ( λ ) = {( \frac{{n}_{d , 2} - {n}_{d , 1}}{{n}_{d , 2} + {n}_{d , 1}} )}^{2}$$

For the case of isorefractive materials, for which n_{d,2}=n_{d,1}, p(λ)=0. This explains the need to adapt the refractive index of a PSA to be used for optical components to that of the materials to be bonded. Typical values for a variety of such materials are set out in Table 1.

TABLE 1

| Material | Refractive index n_{d} |
|---|---|
| Quartz glass | 1.458 |
| Borosilicate crown (BK7) | 1.517 |
| Borosilicate crown | 1.520 |
| Flint | 1.620 |

(Source: Pedrotti, Pedrotti, Bausch, Schmidt, Optik, 1st edn. 1996, Prentice-Hall, Munich. Table 5.1, page 158. Data at λ = 588 nm)

The adhesive tape of the invention is suitable for taking on diverse tasks in the production of solar modules that otherwise have to be realised using different adhesive tapes. The use of the adhesive sheet and/or adhesive tapes of the invention is likewise provided by the present invention.

### BRIEF DESCRIPTION OF THE DRAWINGS

The invention will now be described in greater detail with reference to the drawings, wherein:

FIG. 1 shows the inventive fixing of the solar cells (3) to one another during the production of the solar module.

FIG. 2 shows the inventive use for full-area surface-protection bonding of the sheet (5) of glass of the solar module with single-sided adhesive tapes (6) of the invention, in particular as protection against weathering and/or as protection against marring, and if appropriate for the reinforcement of the sheet of glass, allowing the thickness of the sheet of glass to be reduced. FIG. 2 additionally shows the inventive use of adhesive tapes of the invention for fixing the laminate.

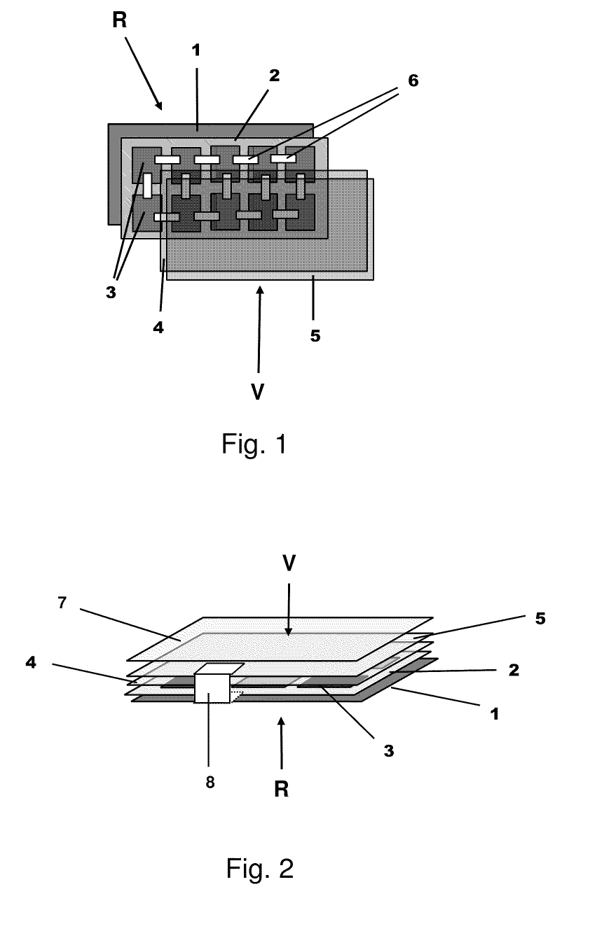

Customary constructions of solar modules can be seen from FIGS. 1 and 2. Solar modules are composed of a multiplicity of solar cells which are fixed to one another in particular with vinyl acetate adhesive tapes, this arrangement being lined on both sides with ethylene films. The reverse of the solar module customarily consists of fluorinated plastics; the front face of the solar modules is formed by a sheet of glass. The electrical contacting of the solar cells has not been shown in the figures.

In the figures:
R=reverse of the module
V=front face of the module
1=fluorinated film
2, 4=ethylene-vinyl acetate film (EVA film)
3=solar cell
5=Glass
6=adhesive tape of the invention; used for solar cell fixing (can be used advantageously here in particular as an elongated planar structure)
7=adhesive sheet of the invention; used for surface protection (can be used here advantageously in particular as a two-dimensionally extended planar structure)
8=adhesive tape of the invention; used for laminate fixing (can be used here with advantage in particular as an elongated planar structure)

### Carrier Materials

For the implementation of the invention described, different requirements are imposed on the carrier material. Particularly relevant in this context is the transmission of light through the carrier film, in order to guarantee an optimum light yield of the solar cells and hence to increase the efficiency of the solar module.

Against this background, a refractive index of the carrier material, n_{d}²⁰, of less than 1.458, preferably below 1.440, more preferably below 1.400, ensures minimum reflection at the interface and in turn increases the light yield. Very preferably, in addition, the carrier material possesses a transmittance of greater than 90% (in accordance with ASTM 1003), which is retained over long periods.

In order to meet the high electrical requirements for use in and on the solar module, there is a need for a carrier material having a high specific surface resistance and a high specific breakdown resistance. There ought to be a specific breakdown resistance of >10¹³ Ωcm and a surface resistance of >10¹⁵Ω, in order to prevent short circuits between the individual solar cells and/or the conductor tracks in the solar module, or else between the aluminium frame of the solar module and the leads in the module. Preferably these resistances are retained within a broad temperature range from −40 to +85° C., since solar modules are subject to severe fluctuations in temperature. The carrier material is advantageously selected accordingly.

The material employed ought to be highly chemically and physically inert, in order to prevent any change in the material as a result of external influences. A very low water absorption is required, so that swelling or destruction of the adhesive tape as a result of weathering effects is avoided. In this way even outdoor application of the adhesive tape on solar modules is able to offer the necessary reliability.

The properties required of the carrier material are achieved in accordance with the invention preferably by fluorinated polyolefinic polymeric films having a fluorine content of greater than or equal to 15%, preferably greater than or equal to 20% and more preferably greater than or equal to 35% by weight. Films are used advantageously in thicknesses of 12 to 100 μm, preferably in thicknesses between 20 and 50 μm. The outstanding chemical and weathering and temperature stability, and also the good electrical and optical properties, of these materials mark out fluorinated polyolefinic polymeric films for the applications described.

The films used in accordance with the invention have a refractive index n_{d}²⁰ (ASTM D-542-50, Abbe refractometer; 20° C.) of less than 1.458 and a transmittance of >90% (in accordance with ASTM 1003), and preferably also have a thermal stability of up to at least 170° C. under mechanical stress, making them outstandingly suitable for the applications referred to. These materials additionally meet the demand for a specific breakdown resistance of >10¹³ Ωcm (ASTM D-257) and a low surface resistance of >10¹⁵Ω (ASTM D-257) in the desired temperature range from −40 to +85° C.

On the basis of the slow-to-react carbon-fluorine bond in fluorinated polymers, they exhibit high chemical and physical stability under heating, and low discoloration on UV exposure. A low water absorption of <0.03% can be demonstrated by fluorinated films by the test method described in ASTM D-570.

Examples of materials of the films employed are as follows: polyvinyl fluoride (PVF), polyethylene-tetrafluoroethylene (PETFE), tetrafluoroethylene/hexafluoroethylene copolymer (FEP) or polyvinylidene fluoride (PVDF).

Besides single-layer films it is also possible, however, to use multi-layer films, which are produced by coextrusion, for example. Advantageously in accordance with the invention it is possible to combine the aforementioned polymer materials with one another. In order to ensure sufficiently high anti-splinter protection, the film ought preferably to have a tensile strength of more than 150 MPa in accordance with ASTM D 882.

Additionally it is advantageous to treat the films beforehand. For example, vapour coating may be carried out with zinc oxide, for example, or varnishes or adhesion promoters may be applied in order to promote the adhesion of the pressure-sensitive adhesive. Further methods are, for example, corona treatment and/or plasma pretreatments and/or the etching of the film.

In addition it may be necessary for the protective film to be furnished with special coatings.

Suitability as an optical coating is possessed with particular preference by coatings which reduce a reflection and/or minimize the marring of the film (known as “hard coatings”). The optical properties are achieved with particular preference by way of a significantly lowered refractive index for the transition between air and optical coating. This is particularly sensible when the refractive index of the carrier film is above 1.440.

In general it is possible to make a distinction between single-layer and multi-layer coatings. In the simplest case, MgF₂ is used as a single-layer coating to minimize the reflection.

MgF₂ has a refractive index of 1.35 at 550 nm. Additionally it is possible, for example, to use metal oxide layers in different coats to minimize the reflection. Typical examples are coats of SiO₂ and TiO₂. Examples of further suitable oxides include hafnium oxide (HfO₂), magnesium oxide (MgO), silicium monoxide (SiO), zirconium oxide (ZrO₂), and tantalum oxide (Ta₂O₅). Furthermore, however, it is also possible to use nitrides, such as SiNₓ, for example.

Also possible, furthermore, is the use of fluorinated polymers as coats with a low refractive index. These are also used very frequently in combination with the aforementioned coats of SiO₂ and TiO₂.

It is also possible, furthermore, to use sol-gel processes. Here, for example, silicones, alkoxides and/or metal alkoxides are used as mixtures and used for coating. Siloxanes are hence also a widespread basis for reflection-reducing coats. Alternatively the siloxanes may have an anti-scratch effect.

In one preferred version the multilayer coats are constructed such that the layer with the lowest refractive index is provided to the light-beam side of the glass and then, step by step, the refractive index is increased towards the carrier film. The same applies to the outside bonding of the single-sided pressure-sensitive adhesive tape on the glass.

The typical coating thicknesses are between 2 and 1000 Å, more preferably between 100 and 500 Å (1 Å=10⁻¹⁰ m). In some cases, depending on coat thickness and chemical composition of the individual optical coats or of the two or more optical coats, there are colour changes, which may then in turn be controlled and/or altered through the thickness of the coating. For the siloxane process coated from solution it is also possible to achieve coat thicknesses of greater than 1000 Å.

A further possibility for reducing the reflection lies in the generation of particular surface structures. The possibility exists, accordingly, of porous coating and of the generation of stochastic or periodic surface structures. In this case the distance between the structures ought to be significantly smaller than the wavelength range of visible light.

In addition to the aforementioned operation of coating from solvent, the optical coats may be applied by vacuum coating methods, such as CVD (chemical vapour deposition) or PIAD (plasma ion assisted deposition), for example.

### Pressure-Sensitive Adhesive

In one very preferred version of the invention specific (meth)acrylate PSAs are employed.

Meth(acrylate) PSAs which are used advantageously in accordance with the invention and are preferably obtainable by free-radical polymerization are composed of at least 50% by weight of at least one acrylic monomer from the group of the compounds of the following general formula:

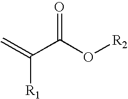

where R₁ is H or CH₃ and the radical R₂ is H or CH₃ or is chosen from the group of the branched or unbranched, saturated alkyl groups having 1-30 carbon atoms.

The monomers are preferably chosen such that the resulting polymers can be used, at room temperature or higher temperatures, as PSAs, in particular such that the resulting polymers possess pressure-sensitive adhesive properties in accordance with the Handbook of Pressure Sensitive Adhesive Technology by Donatas Satas (van Nostrand, New York 1989).

The (meth)acrylate PSAs have a refractive index n_{d}>1.430 or more at 20° C. (Abbe refractomer; cf. test method A).

The (meth)acrylate PSAs can be obtained preferably by polymerization of a monomer mixture which is composed of acrylic esters and/or methacrylic esters and/or the corresponding free acids, with the formula CH₂═CH(R₁)(COOR₂), where R₁ is H or CH₃ and R₂ is an alkyl chain having 1-20 C atoms or H.

The molar masses M_{w} of the polyacrylates employed are preferably M_{w}≧200 000 g/mol.

Use is made very preferably of acrylic or methacrylic monomers which consist of acrylic and methacrylic esters with alkyl groups of 4 to 14 C atoms, preferably comprising 4 to 9 C atoms. Specific examples, without wishing to be restricted by this recitation, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as isobutyl acrylate, 2-ethylhexyl acrylate, 2-ethylhexyl methacrylate, isooctyl acrylate and isoctyl methacrylate, for example.

Further classes of compound which can be used are monofunctional acrylates and/or methacrylates of bridged cycloalkyl alcohols, consisting of at least 6 C atoms. The cycloalkyl alcohols may also be substituted, as for example by C-1-6 alkyl groups, halogen atoms or cyano groups. Specific examples are cyclohexyl methacrylates, isobornyl acrylate, isobornyl methacrylates, and 3,5-dimethyladamantyl acrylate.

One procedure uses monomers which carry polar groups such as carboxyl radicals, sulphonic and phosphonic acid, hydroxy radicals, lactam and lactone, N-substituted amide, N-substituted amine, carbamate radicals, epoxy radicals, thiol radicals, alkoxy radicals, cyano radicals, ether or the like.

Moderate basic monomers are, for example, N,N-dialkyl-substituted amides, such as N,N-dimethylacrylamide, N,N-dimethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxymethyl)methacrylamide, N-methylolacrylamide, N-(ethoxymethyl)acrylamide, N-isopropyl acrylamide, this recitation not being conclusive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glycerol methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, dimethylacrylic acid, this recitation not being conclusive.

A further very preferred procedure uses, as monomers, vinyl esters, vinyl ethers, vinyl halides, vinylidene halides, vinyl compounds with aromatic rings and heterocycles in α position. Here again, mention may be made, non-exclusively, of certain examples: vinyl acetate, vinylformamide, vinylpyridine, ethyl vinyl ether, vinyl chloride, vinylidene chloride, and acrylonitrile.

Use is made in particular, with particular preference, of comonomers which carry at least one aromatic, which possess a refractive index-increasing effect. Suitable components are aromatic vinyl compounds, such as styrene, for example, it being possible with preference for the aromatic nuclei to be composed of C₄ to C₁₈ building blocks and also to contain heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate and methacrylate, 2-naphthyl acrylate and methacrylate, and mixtures of those monomers, this recitation not being conclusive.

In one preferred variant of the invention the (meth)acrylate PSAs have a refractive index n_{d}>1.47 at 20° (measured with the Abbe refractomer; test method A).

As a result of the increase in the aromatic fraction in the composition of the PSA there is an increase in the refractive index of the PSA, and the scattering between glass and PSA by light is minimized. Using aromatic comonomers thus helps increase the refractive index of the PSA.

It is also possible, advantageously, for ageing inhibitors, in the form, for example, of primary and secondary antioxidants or in the form of light stabilizers, to have been added.

Additionally it is possible to admix crosslinkers and crosslinking promoters. Examples are, for example, difunctional or polyfunctional isocyanates, (including those in blocked form) or difunctional or polyfunctional epoxides. It is also possible, furthermore, for heat-activatable crosslinkers to have been added, such as Lewis acid or metal chelates, for example.

### Preparation Processes for the (Meth)Acrylate PSAs

For the polymerization the monomers are chosen such that the resulting polymers can be used, at room temperature or higher temperatures, as PSAs, in particular such that the resulting polymers possess pressure-sensitive adhesive properties in accordance with the Handbook of Pressure Sensitive Adhesive Technology by Donatas Satas (van Nostrand, New York 1989).

In order to obtain a polymer glass transition temperature T_{g} which is preferred for PSAs, of ≦25° C., the monomers, in accordance with the statements above, are very preferably selected, and the quantitative composition of the monomer mixture advantageously chosen, such that, in accordance with the Fox equation (E1) (cf. T. G. Fox, Bull. Am. Phys. Soc. 1 (1956) 123), the desired T_{g} value is obtained for the polymer.

$$\frac{1}{{T}_{g}} = {\sum }_{n} \frac{{w}_{n}}{{T}_{g , n}} \qquad ( E1 )$$

In this equation, n represents the serial number of the monomers employed, wₙ the mass fraction of the respective monomer n (% by weight), and T_{g,n} the respective glass transition temperature of the homopolymer of the respective monomer n, in K.

For the preparation of the poly(meth)acrylate PSAs use is made in one preferred embodiment of purified monomers, i.e. the monomers have been freed from stabilizers.

In one preferred embodiment preparation is effected by the implementation of a conventional free-radical addition polymerization. For the polymerizations which proceed by a free-radical mechanism it is preferred to use initiator systems which additionally comprise further free-radical initiators for the polymerization, more particularly thermally decomposing, radical-forming initiators of azo or peroxo type. In principle, however, all typical initiators familiar to the skilled worker for acrylates are suitable. The production of C-centred free radicals is described in Houben Weyl, Methoden der Organischen Chemie, vol. E 19a, pp. 60-147. These methods are preferentially employed in analogy.

Examples of free-radical sources are peroxides, hydroperoxides, and azo compounds; as a number of non-exclusive examples of typical free-radical initiators, mention may be made here of potassium peroxodisulphate, dibenzoyl peroxide, cumene hydroperoxide, cyclohexanone peroxide, di-t-butyl peroxide, azodiisobutyronitrile, cyclohexylsulphonyl acetyl peroxide, diisopropyl percarbonate, t-butyl peroctoate, benzpinacol. One very preferred version uses, as a free-radical initiator, 1,1′-azobis(cyclohexanecarbonitrile) (Vazo 88™ from DuPont) or azodiisobutyronitrile (AIBN).

The average molecular weights M_{w} of the PSAs formed in the course of the free-radical polymerization are very preferably chosen such that they are situated within a range from 200 000 to 4 000 000 g/mol; specifically for further use as an electrically conductive, pressure-sensitive hotmelt adhesive with resilience, PSAs are prepared having average molecular weights M_{w} of 400 000 to 1 400 000 g/mol. The average molecular weight is determined via size exclusion chromatography (GPC; eluent: THF with 0.1% by volume trifluoroacetic acid; measurement at 25° C.; preliminary column: PSS-SDV, 5μ, 10³ Å, ID 8.0 mm×50 mm; separation: columns PSS-SDV, 5μ, 10³ and also 10⁵ and 10⁶ Å each with ID 8.0 mm×300 mm; sample concentration: 4 g/l, flow rate: 1.0 ml per minute; measurement against PMMA standards).

The polymerization may be carried out in bulk, in the presence of one or more organic solvents, in the presence of water, or in mixtures of organic solvents and water. The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl acetate, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether), or mixtures thereof. The aqueous polymerization reactions may be admixed with a water-miscible or hydrophilic cosolvent in order to ensure that in the course of monomer conversion the reaction mixture is present in the form of a homogenous phase. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organosulphides, sulphoxides, sulphones, alcohol derivatives, hydroxyether derivatives, amino alcohols, ketones and the like, and also derivatives and mixtures thereof.

Depending on conversion rate and temperature, the polymerization time is between 2 and 72 hours. The higher the reaction temperature that can be chosen, in other words the higher the thermal stability of the reaction mixture, the lower the reaction time that can be chosen.

To initiate the polymerization it is essential, for the initiators which decompose thermally, that heat is input. The polymerization can be initiated for the thermally decomposing initiators by heating to 50 to 160° C., depending on the type of initiator

Another advantageous preparation process for the poly(meth)acrylate PSAs is anionic polymerization. In this case the reaction medium used comprises preferably inert solvents, such as aliphatic and cycloaliphatic hydrocarbons, for example, or else aromatic hydrocarbons.

The living polymer is in this case generally represented by the structure P_{L}(A)-Me where Me is a metal from group I, such as lithium, sodium or potassium, for example, and P_{L}(A) is a growing polymer formed from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium or octyllithium, this recitation making no claim to completeness. Furthermore, initiators based on samarium complexes are known for the polymerization of acrylates and can be used here.

It is also possible, furthermore, to use difunctional initiators, such as 1,1,4,4-tetraphenyl-1,4-dilithiobutane or 1,1,4,4-tetraphenyl-1,4-dilithioisobutane, for example. Coinitiators may likewise be employed. Suitable coinitiators include lithium halides, alkali metal alkoxides or alkylaluminium compounds. In one very preferred version the ligands and coinitiators are chosen such that acrylate monomers, such as n-butyl acrylate and 2-ethylhexyl acrylate, for example, can be polymerized directly and do not have to be generated in the polymer by transesterification with the corresponding alcohol.

Furthermore, the polymerization is controlled so that the conversion in the polymerization is greater than 99.5%. This can be achieved first by longer polymerization times and also by a higher polymerization temperature. With free-radical polymerizations, moreover, there is the possibility of increasing the conversion by repeated addition of quick-decomposing free-radical initiators.

### Release Liner

To protect the open PSA, the single-sided—in particular—pressure-sensitive adhesive tape is lined preferably with a release liner. Suitable release papers are glassine, HDPE or LDPE liners, which in one preferred version have siliconization as a release layer. In one very preferred embodiment of the invention a film-based release liner is used. The film-based release liner ought in one very preferred embodiment to have siliconization as the release agent. Moreover, the film-based release liner ought to possess an extremely smooth surface, so that there is no structuring of the PSA by the release liner. This is achieved preferably through the use of PET films that are free from antiblocking agent, in combination with silicone systems which have been coated from solution.

### Product Constructions

Depending on the intended use, planar structures with elongated extension or planar structures with two-dimensional extension are employed; see also earlier on above. In accordance with the dimensions, these variant embodiments may merge with one another. Where the present specification refers to pressure-sensitive adhesive tapes or to pressure-sensitive adhesive sheets, no distinction is made by this as to the two planar structures, unless explicitly stated. In particular, in the context of the description of the construction, the intention in each case is to encompass both variant embodiments.

The pressure-sensitive adhesive tapes may advantageously be constructed as follows:
a] single-layer adhesive films composed of a film carrier layer and a pressure-sensitive adhesive;
b] single-layer adhesive films composed of a film carrier layer, a pressure-sensitive adhesive and a release liner.

For single-sided pressure-sensitive adhesive tapes the PSA coatweight in accordance with the invention is preferably between 10 and 150 g/m², more preferably between 20 and 100 g/m².

### Use

The use of the single-sided pressure-sensitive adhesive tapes on the glass window may take place in accordance with a variety of mechanisms. In one inventive embodiment the glass window is bonded over its full area with the transparent adhesive tape. In this case the single-sided pressure-sensitive adhesive tape is oriented to the sun side. This is the preferred inventive version. Furthermore, however, the pressure-sensitive adhesive tape may also be bonded to the reverse of the protective glass, and thus faces the solar cell.

The further inventive use embraces the use of the adhesive tape for fixing solar cells, as shown in FIG. 1. For this purpose it is preferred to use individual strips of pressure-sensitive tape. Another inventive use encompasses the use of the adhesive tape for laminate fixing, as shown in FIG. 2. For this purpose it is preferred again to use strips of pressure-sensitive adhesive tape.

### Application

In the first step, in one preferred procedure, the single-sided pressure-sensitive adhesive tape is cut to the utilization width or to the required utilization size (area size).

For adhesive bonding as an anti-splinter film, in the following step, full-area lamination takes place to the glass. For this purpose, in a first step, the release film is removed, and then lamination takes place to the glass window, using the exposed PSA. For this purpose it may have been necessary to wet (with water or with a soap solution, for example) the glass and/or the PSA in order to allow the PSA to be laminated extensively and without bubbles.

For all applications it is generally the case that the single-sided pressure-sensitive adhesive tape is laminated on from one side, so that air can escape from the other side. This can be accomplished by means, for example, of a pressure roller or rubber roller or roller doctor or squeeze roll or knife.

### Test Methods

### A. Refractive Index

The refractive index of the PSA and of the fluorinated polymer films is measured in accordance with ASTM D-542-50 (25 μm thick samples; 20° C.; 589 nm) by the Abbe principle.

### B. Transmittance

The transmittance is determined at 550 nm in accordance with ASTM D1003. The system measured was the assembly of optically transparent adhesive tape and glass plate. For comparison, measurement was likewise carried out after 1000 h of storage at 85° C.

### C. Bond Strength

The peel strength (bond strength) was tested in accordance with PSTC-1. The adhesive tape is applied to a glass plate. A strip of the adhesive tape 2 cm wide is adhered by being rolled over back and forth three times using a 2 kg roller. The plate is clamped in and the self-adhesive strip is peeled off from its free end in a tensile testing machine under a peel angle of 180° and at a speed of 300 mm/min. The strength is reported in N/cm.

### D. Light Stability

The assembly formed from adhesive tape and glass plate, in a size of 4×20 cm², is covered over half its area with a strip of card and then irradiated from a distance of 50 cm with Osram Ultra Vitalux 300 W lamps for a period of 300 h. Following irradiation, the strip of card is removed and the discoloration is assessed visually.

A “pass” is scored in the test if the test strips show no different discolorations at all and if there is no decomposition of the carrier.

### E. Falling-Ball Test

The adhesive tape is fixed without bubbles to a 1.1 mm glass sheet from Schott. The bond area is 4×6 cm. Subsequently the assembly was stored for 48 h at 23° C. and 50% humidity (relative humidity). The assembly is then fixed in a holder so that the glass surface is aligned horizontally (the glass side is upwards). 1 m above the glass surface, a steel ball of 63.7 g is fixed. The steel ball is then subjected to free fall. A “pass” is scored in the test when less than 5% by weight of the glass splinters detach after the falling-ball test. The loss is determined by gravimetry (determination of the weight before and after the falling-ball test).

### F. Electrical Conductivity

The volume resistance was measured in accordance with ASTM D-257-78. Measurement took place at 23° C. and 100° C. The values are reported in Ωcm.

### G. Bond Strength at 150° C.

The peel strength (bond strength) was tested in accordance with PSTC-1. The adhesive tape is applied to a glass plate. A strip of the adhesive tape 2 cm wide is adhered by being rolled over back and forth six times using a 2 kg roller. The plate is clamped in and heated at 150° C. until the adhesive tape has attained this temperature. The self-adhesive strip is peeled off from its free end in a tensile testing machine under a peel angle of 180° and at a speed of 300 mm/min. The strength is reported in N/cm.

### Preparation of Polymer 1:

The polymerization was carried out using monomers purified to remove stabilizers. The monomers were purified by distillation. A 2 l glass reactor conventional for free-radical polymerizations was charged with 80 g of acrylic acid, 140 g of n-butyl acrylate, 200 g of 2-ethylhexyl acrylate and 300 g of acetone/isopropanol (97:3). After nitrogen gas had been passed through the reactor for 45 minutes, with stirring, it was heated to 58° C. and 0.2 g of Vazo67™ (2,2′-azodi(2-methylbutyronitrile), DuPont) was added. Subsequently the external heating bath was heated to 75° C. and the reaction was carried out constantly at this external temperature. After a reaction time of 1 h a further 0.2 g of Vazo 67™ (2,2′-azodi(2-methylbutyronitrile), DuPont) was added. After 3 h and again after 6 h, 150 g of acetone/isopropanol mixture were added for dilution. For the reduction of the residual initiators, 0.4 g portions of Perkadox 16™ (di(4-tert-butylcyclohexyl) peroxydicarbonate, Akzo Nobel) were added after 8 h and again after 10 h. The reaction was terminated after a reaction time of 48 h, and the product was cooled to room temperature. Polymer conversion was 99.6% (determined via GC-MS). The refractive index, measured by test method A, was 1.475.

### Preparation of Polymer 2:

The polymerization was carried out using monomers purified to remove stabilizers. The monomers were purified by distillation. A 2 l glass reactor conventional for free-radical polymerizations was charged with 60 g of acrylic acid, 340 g of n-butyl acrylate and 300 g of acetone/isopropanol (97:3). After nitrogen gas had been passed through the reactor for 45 minutes, with stirring, it was heated to 58° C. and 0.2 g of Vazo67™ (2,2′-azodi(2-methylbutyronitrile), DuPont) was added. Subsequently the external heating bath was heated to 75° C. and the reaction was carried out constantly at this external temperature.

After a reaction time of 1 h a further 0.2 g of Vazo 67™ (2,2′-azodi(2-methylbutyronitrile), DuPont) was added. After 3 h and again after 6 h, 150 g of acetone/isopropanol mixture were added for dilution. For the reduction of the residual initiators, 0.4 g portions of Perkadox 16™ (di(4-tert-butylcyclohexyl) peroxydicarbonate, Akzo Nobel) were added after 8 h and again after 10 h. The reaction was terminated after a reaction time of 48 h, and the product was cooled to room temperature. Polymer conversion was 99.7% (determined via GC-MS). The refractive index, measured by test method A, was 1.474.

### Preparation of Polymer 3:

A 2 l glass reactor conventional for free-radical polymerizations was charged with 60 g of acrylic acid, 340 g of n-butyl acrylate and 300 g of acetone/isopropanol (97:3). After nitrogen gas had been passed through the reactor for 45 minutes, with stirring, it was heated to 58° C. and 0.2 g of Vazo67™ (2,2′-azodi(2-methylbutyronitrile), DuPont) was added. Subsequently the external heating bath was heated to 75° C. and the reaction was carried out constantly at this external temperature. After a reaction time of 1 h a further 0.2 g of Vazo 67™ (2,2′-azodi(2-methylbutyronitrile), DuPont) was added. After 3 h and again after 6 h, 150 g of acetone/isopropanol mixture were added for dilution. The reaction was terminated after a reaction time of 24 h, and the product was cooled to room temperature. Polymer conversion was 97.6% (determined via GC-MS). Subsequently the product was blended homogeneously in solution with 30% by weight of Sylvares™ TP 95 (terpene-phenol resin, softening temperature 95° C., Arizona). The refractive index after blending, measured by test method A, was 1.479.

### Blending of the Crosslinker Solution:

Polymer solution 1 or 2 was blended with 0.3% by weight of aluminium(III) acetylacetonate, with stirring, and diluted with acetone to 30% solids content.

### Film 1

Film 1 used was a polyvinyl fluoride film having a thickness of 25 μm. The fluorine weight fraction is 41%. The refractive index, measured by test method A, was 1.458.

### Film 2

Film 2 used was an ethylene tetrafluoroethylene copolymer film having a thickness of 25 μm. The fluorine weight fraction is 59%. The refractive index, measured by test method A, was 1.398.

### Reference Film 1

Reference film 1 used was an HDPE film having a thickness of 25 μm. The fluorine weight fraction is 0%. The refractive index, measured by test method A, was 1.540.

### Reference Film 2

Reference film 2 used was a PET film having a thickness of 25 μm. The fluorine weight fraction is 0%. The refractive index, measured by test method A, was 1.604.

### Production of Adhesive Tape Specimen Example 1:

Film 1 was coated with polymer 1 using a coating bar. Then the solvent was slowly evaporated off. The adhesive tape specimens were subsequently dried at 120° C. for 10 minutes. The coatweight after drying was 50 g/m².

### Production of Adhesive Tape Specimen Example 2:

Film 1 was coated with polymer 2 using a coating bar. Then the solvent was slowly evaporated off. The adhesive tape specimens were subsequently dried at 120° C. for 10 minutes. The coatweight after drying was 50 g/m².

### Production of Adhesive Tape Specimen Example 3:

Film 2 was coated with polymer 1 using a coating bar. Then the solvent was slowly evaporated off. The adhesive tape specimens were subsequently dried at 120° C. for 10 minutes. The coatweight after drying was 50 g/m².

### Production of Adhesive Tape Specimen Example 4:

Film 2 was coated with polymer 2 using a coating bar. Then the solvent was slowly evaporated off. The adhesive tape specimens were subsequently dried at 120° C. for 10 minutes. The coatweight after drying was 50 g/m².

### Production of Adhesive Tape Specimen Reference Example 1:

Reference film 1 was coated with polymer 3 using a coating bar. Then the solvent was slowly evaporated off. The adhesive tape specimens were subsequently dried at 120° C. for 10 minutes. The coatweight after drying was 50 g/m².

### Production of Adhesive Tape Specimen Reference Example 2:

Reference film 2 was coated with polymer 3 using a coating bar. Then the solvent was slowly evaporated off. The adhesive tape specimens were subsequently dried at 120° C. for 10 minutes. The coatweight after drying was 50 g/m².

### Results

Following the production of the test specimens, first of all the bond strengths to glass were measured for all of the examples. The procedure here was in accordance with test method C, bond strength. The values are collected in Table 1.

TABLE 1

| Example | BS glass (Test C) |
|---|---|
| 1 | 4.3 |
| 2 | 4.0 |
| 3 | 4.4 |
| 4 | 4.3 |
| Reference 1 | 5.4 |
| Reference 2 | 5.7 |

BS: Instantaneous bond strength in N/cm

The values measured indicate that the pressure-sensitive adhesive tapes used exhibit high instantaneous bond strengths to glass and thus develop effective adhesion. The difference between the inventive examples and reference examples 1 and 2 was small. The reference examples exhibited a somewhat higher level of bond strength.

Furthermore, the transmittance test, test B, was carried out with all of the examples. This test was used to ascertain whether there is sufficiently high transmittance provided when the adhesive anti-splinter tape is bonded to the glass window. The values measured for the assembly are set out in Table 2.

TABLE 2

| | Transmittance | |
|---|---|---|
| | (test B, | Transmittance |
| Example | instantaneous) | (test B, 100 h) |
| 1 | 91% | 91% |
| 2 | 92% | 92% |
| 3 | 91% | 91% |
| 4 | 91% | 91% |
| Reference 1 | 68% | 65% |
| Reference 2 | 92% | 84% |

From Table 2 it can be seen that all of examples 1-4 exhibit extremely high transmittance values of 90% or more. Reference example 1 shows that the transmittance is significantly lowered by the non-transparent carrier. Reference example 2 demonstrates that, after ageing, transmittance has gone down markedly and is below the target value. The inventive examples 1-4, in contrast, are all stable with respect to temperature ageing.

Furthermore, all of the examples were subjected to the falling-ball test, test E. The results are set out in Table 3 below.

TABLE 3

| Example | Falling ball test (test E) |
|---|---|
| 1 | <2% by weight* |
| 2 | <2% by weight* |
| 3 | <2% by weight* |
| 4 | <2% by weight* |
| Reference 1 | <2% by weight* |
| Reference 2 | <2% by weight* |
| Glass (3 mm) | 100% by weight* |

*based on the weight of the glass

From the results it is evident that, as a result of the specific construction of the adhesive tapes (structure of the backing and of the adhesive), the profile of properties has been optimized in such a way that very good anti-splinter protection exists. The test was passed clearly by all of the examples (1-4). In no case was there more than 2% by weight detachment of the glass splinters. The reference examples likewise showed very good anti-splinter protection. Additionally, as a reference, a 3 mm thick sheet of glass was subjected to the falling-ball test. The result demonstrates that the glass is destroyed by the impact of the ball. Hence it was shown that the examples (all carried out with a glass plate 1.1 mm thick) ensure anti-splinter protection and that therefore the glasses can be made thinner and hence a weight saving achieved.

To simulate long-term irradiation by outdoor light, furthermore, the light stability test, test D, was carried out. In this test the examples are irradiated with intense incandescent lamps for 300 h, simulating sunlight exposure. The results are assembled in Table 4.

TABLE 4

| Example | Light stability (Test D) |
|---|---|
| 1 | pass |
| 2 | pass |
| 3 | pass |
| 4 | pass |
| Reference 1 | discoloration |
| Reference 2 | discoloration/decomposition of carrier |

The results demonstrate that examples 1 to 4 possess high ageing stabilities.

Accordingly the pressure-sensitive adhesive tapes of the invention can also be used for long-term applications. There is no discoloration and nor are there any instances of decomposition of the carrier to reduce the incident light or breakdown mechanically. Reference examples 1 and 2, in contrast, exhibit significant discoloration and likewise, in the case of example 2, decomposition of the carrier material.

The tests so far have shown that the inventive examples are outstandingly suitable as an adhesive anti-splinter tape for glass sheets in solar panels. To test their suitability as a pressure-sensitive adhesive tape for the fixing of solar cells, however, there are further requirements to be met, since in that case there is direct contact with electrically conductive compounds which should, consequently, not be adversely affected by bonding with the tape. For this reason, electrical conductivity measurements were carried out in accordance with test method F. The parameter evaluated was the electrical conductivity of the carrier material and of the PSA. The results are set out in Table 5.

TABLE 5

| | Electrical | Electrical | Electrical |
|---|---|---|---|
| | conductivity | conductivity | conductivity |
| | (Test F) | (Test F) | (Test F) |
| Example | 23° C./Carrier | 23° C./PSA | 100° C./PSA |
| 1 | 10¹³ Ω cm | 10¹⁵ Ω cm | 10¹² Ω cm |
| 2 | 10¹³ Ω cm | 10¹⁵ Ω cm | 10¹² Ω cm |
| 3 | 10¹⁶ Ω cm | 10¹⁵ Ω cm | 10¹² Ω cm |
| 4 | 10¹⁶ Ω cm | 10¹⁵ Ω cm | 10¹² Ω cm |
| Reference 1 | 10¹⁶ Ω cm | 10¹⁴ Ω cm | 10¹⁰ Ω cm |
| Reference 2 | 10¹⁶ Ω cm | 10¹⁴ Ω cm | 10¹⁰ Ω cm |

The values in Table 5 demonstrate the fact that the carrier materials of examples 1 to 4 and also of reference examples 1 and 2 all exhibit high electrical resistances and are therefore very good insulators. The same is true with regard to the electrical conductivity of the PSAs. Only the measurements at 100° C. show that there is generally an increase in the electrical conductivity. Reference examples 1 and 2 in particular demonstrate that, at high temperature, the PSA inclines towards an increased electrical conductivity. This could be a problem, since in summertime, with strong incident light, the solar panels can heat up to a very great extent, and, accordingly, the increasing electrical conductivity may constitute a problem with regard, for example, to short circuits but also to corrosion.

For the pressure-sensitive adhesive tape for fixing the laminate, moreover, a requirement is that it must pass through a high-temperature operation. For this reason, additionally, a bond strength test was carried out at 150° C. This was done in accordance with test method G. The results are set out in Table 6 below.

TABLE 6

| | Bond strength (Test G) |
|---|---|
| Example | 150° C. |
| 1 | 0.7 N/cm |
| 2 | 0.8 N/cm |
| 3 | 0.7 N/cm |
| 4 | 0.7 N/cm |
| Reference 1 | n.d. |
| Reference 2 | 0.2 N/cm |

n.d. Not measurable, since carrier is much too soft at 150° C.

From Table 6 it is evident that the bond strengths of inventive examples 1 to 4 have decreased significantly. As compared with reference 2, however, it is still possible to measure higher bond strengths, and so it is apparent that reference 2 suffers a very significant loss in bond strength at very high temperatures and is therefore not very suitable for high-temperature bonding applications. Problems may occur in particular with repulsion forces and stresses which develop at 150° C. and may therefore lead to the detachment of the pressure-sensitive adhesive tape. Reference example 1, in contrast, cannot be used at all, since in that case the carrier softens very severely at 150° C. Examples 1 to 4, in contrast, show a very balanced behaviour and can therefore be used to very good effect for laminate fixing. Moreover, the overall thickness of examples 1 to 4 is approximately 75 μm, and so, subsequently, aluminium frame profiles can still be bonded over them. These profiles are then fixed with double-sided foam-backed pressure-sensitive adhesive tapes, which are able to compensate the 75 μm unevennesses occasioned by the remanence of the pressure-sensitive adhesive tape.

1. Pressure-sensitive adhesive tape comprising
(i) a transparent carrier film and
(ii) a layer of a transparent pressure-sensitive adhesive,
wherein
the carrier film has a refractive index n_{d}²⁰ of not more than 1.458 and a transmittance of greater than or equal to 90%,
the pressure-sensitive adhesive layer has a refractive index n_{d}²⁰ of at least 1.470 and a transmittance of at least 90%;
the transmittance of the adhesive tape in the bonded state on a glass plate is at least 90%.

2. Pressure-sensitive adhesive tape according to claim 1, wherein the refractive index n_{d}²⁰ of the carrier film is not more than 1.440.

3. Pressure-sensitive adhesive tape according to claim 1, wherein the carrier film has a specific breakdown resistance of at least 10¹³ Ωm.

4. Pressure-sensitive adhesive tape according to claim 1, wherein the carrier film has a surface resistance of at least 10¹⁵Ω.

5. Pressure-sensitive adhesive tape according to claim 1, wherein a film based on fluorinated polyolefinic polymers is used as carrier film.

6. Pressure-sensitive adhesive tape according to claim 1, wherein the fluorine content of the carrier film is at least 15%, by weight.

7. Pressure-sensitive adhesive tape according to claim 1, wherein a multilayer film is used as carrier film.

8. Pressure-sensitive adhesive tape according to claim 1, wherein the carrier film is provided with a reflection-reducing and/or a surface-protecting coating.

9. Pressure-sensitive adhesive tape according to claim 1, wherein a (meth)acrylate-based composition is used as pressure-sensitive adhesive.

10. A method for bonding components in the production of solar modules, said method comprising bonding such components with an adhesive tape according to claim 1.

11. Method according to claim 10, which is carried out for fixing solar cells, as surface protection and/or for fixing laminates.
